(19) United States
(12) Patent Application Publication
(10) Pub. No.: US 2019/0299870 A1
(43) Pub. Date: Oct. 3, 2019

(54) GUN CARRIER FOR ALL-TERRAIN VEHICLES

(71) Applicant: Jaren McCourt, Price, UT (US)

(72) Inventor: Jaren McCourt, Price, UT (US)

(21) Appl. No.: 16/365,909

(22) Filed: Mar. 27, 2019

Related U.S. Application Data
(60) Provisional application No. 62/649,060, filed on Mar. 28, 2018.

(51) Int. Cl. B60R 7/14; F41C 33/06

(52) U.S. Cl. CPC B60R 7/14; F41C 33/06

(57) ABSTRACT

A gun carrier for all-terrain vehicles includes a front end and a rear end. The front end is narrower than the rear end so that the gun carrier does not impede upon the passenger space of the all-terrain vehicle. The gun carrier includes an inner compartment configured to house one or more guns. The inner compartment includes a padded inner lining. The gun carrier also includes a door disposed on the side of the gun carrier that is biased to open when a latch is manipulated. The gun carrier can be secured to the all-terrain vehicle in such a way so that passengers can quickly retrieve a gun from within the gun carrier with minimal movement and noise.

### CROSS-REFERENCE TO RELATED APPLICATIONS

This application claims priority to and the benefit of U.S. Provisional Application Ser. No. 62/649,060 entitled “Gun Carrier for All-Terrain Vehicles”, filed on Mar. 28, 2018, the entire content of which is incorporated by reference herein in its entirety.

### BACKGROUND OF THE INVENTION

### 1. The Field of the Invention

The present invention relates generally to systems, methods, and apparatus for carrying guns. More specifically, the present invention relates to systems, methods, and apparatus for carrying guns on all-terrain vehicles.

### 2. Background and Relevant Art

Gun users, such as hunters, often drive all-terrain vehicles to navigate through off-road areas and rough terrain en-route to a camp destination or look-out point. Hunters may also drive all-terrain vehicles while searching for game. Hunting gear, including guns, bows, rifles, and other gear, are generally packed onto the all-terrain vehicle during transport. Hunters may store guns in individual cases and place them in a storage compartment of the all-terrain vehicle, or they may store the guns in or on the vehicle without a case.

However, typical all-terrain vehicles lack storage space suitable or large enough for gun storage. For example, storage spaces within all-terrain vehicles typically lack straps or other securement means to keep guns from jostling. Also, storage spaces typically lack padded internal surfaces that would protect guns during bumpy transport over rocky roads.

Typical guns and gun cases are bulky and awkward to store in all-terrain vehicles. All-terrain vehicles are generally compact vehicles that do not provide enough space to conveniently and safely hold such weapons. As such, all-terrain vehicles are not equipped to accommodate such bulky equipment without reducing the space and comfort level available to the driver and passengers.

Currently, methods and apparatus for transporting guns and other hunting gear on all-terrain vehicles result in jostling of the guns due to bumpy road or trail conditions on which the vehicle is traveling. This jostling is noisy and can damage the guns and gun cases. More secure cases or other storage compartments used to transport guns, are difficult to access quickly and quietly. This is problematic, for example, when a target is spotted while driving. Under such circumstances, a hunter may want to stop the vehicle and retrieve a gun quickly and quietly, with the least amount of movement possible so as not to be detected.

For example, using typical gun carriers on all-terrain vehicles requires substantial repositioning and a number of steps to retrieve a gun after the vehicle is stopped. These steps, such as unzipping the carrier, or undoing Velcro or other straps holding a gun inside the carrier, can be noisy and time consuming. Also, carrier configured to be secured to the top, front, rear, or side of the all-terrain vehicle may require a passenger to get out of the vehicle and walk around the vehicle to access his or her gun.

Such repositioning and added gun retrieval steps may cause the passenger to miss a window of time before the target, such as an animal, is startled and/or runs away. Thus, the repositioning and retrieval of guns from typical gun carriers require noise and movement that is disadvantageous to a hunter.

Accordingly, there are a number of disadvantages in the art that can be addressed.

### BRIEF SUMMARY OF THE INVENTION

Embodiments of the present invention solve one or more problems in the art with systems, methods, and apparatus to carry guns on all-terrain vehicles. In particular, in one embodiment of the present invention, a gun carrier includes a body that has a head portion and a rear portion. The body forms an inner compartment configured to house one or more guns. In addition, the gun carrier includes a tapered portion extending upward from a bottom of the rear portion to the head portion and a door disposed on a vertical side surface of the body. The door provides access to the inner compartment. The gun carrier also includes one or more fasteners secured to a top surface of the body, which are configured to secure the gun carrier to one or more upper frame members of an all-terrain vehicle during use.

In one embodiment, a gun carrier that can be mounted to an all-terrain vehicle includes a body that forms an inner compartment. A tapered portion extends upward from a rear portion of the body to a head portion of the body and one or more fasteners secure to a top surface of the body are configured to secure the body to upper frame members of an all-terrain vehicle. As such, the body extends downward from the upper frame members and is disposed between headspaces of passengers positioned in the vehicle. Also, the tapered portion extends upward so that the head portion resides above the headspaces of passengers positioned in the vehicle to which the gun carrier is secured.

In one embodiment, a method of carrying a gun on an all-terrain vehicle includes providing a gun carrier. The gun carrier includes a body having a rear portion and a head portion. The gun carrier also includes a tapered portion extending upward and forward from a bottom of the rear portion to the head portion. Also, two or more fasteners are secured to a top surface of the body. In such an embodiment, the two or more fasteners include a front stationary fastener positioned toward the head portion and a rear adjustable fastener positioned toward the rear portion.

The embodiment of the method further includes adjusting a position of the rear adjustable fastener to be spaced apart from the front stationary fastener to match a spacing between two upper frame members of the all-terrain vehicle. Also, the method includes securing the two or more fasteners to the upper frame members of the all-terrain vehicle so that the tapered portion extends above headspaces of the all-terrain vehicle and the body extends vertically downward from the upper frame members between headspaces of the all-terrain vehicle.

Additional features and advantages of exemplary embodiments of the invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims or may be learned by the practice of such exemplary embodiments as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a perspective view of an embodiment of a gun carrier, according to the present disclosure;

FIG. 2 illustrates a top view of an embodiment of a gun carrier, according to the present disclosure;

FIG. 3 illustrates a side view of an embodiment of a gun carrier, according to the present disclosure;

FIG. 4 illustrates a perspective view of an embodiment of a gun carrier with an open door, according to the present disclosure;

FIG. 5 illustrates an embodiment of two inserts of a gun carrier, according to the present disclosure;

FIG. 6 illustrates an embodiment of a gun carrier with inserts disposed therein and an open door, according to the present disclosure;

FIG. 7 illustrates a perspective view of an embodiment of a gun carrier secured to an all-terrain vehicle, according to the present disclosure;

FIG. 8 illustrates a side view of an embodiment of a gun carrier secured to an all-terrain vehicle, according to the present disclosure; and

FIG. 9 shows a front view of an embodiment of a gun carrier secured to an all-terrain vehicle, according to the present disclosure.

### DETAILED DESCRIPTION OF THE PREFERRED EMBODIMENTS

Embodiments of the present invention extend to systems, methods, and apparatus for Error! Reference source not found. carrying guns on all-terrain vehicles. In particular, in one embodiment of the present invention, a gun carrier includes a body that forms an inner compartment. The body has a front end and a rear end and the inner compartment is configured to house at least one gun. In one embodiment, the front end of the body is narrower than the rear end of the body. Also, in one embodiment, the gun carrier includes a door disposed on a side of the body, which provides access to the inner compartment.

The apparatus and methods disclosed herein can carry one or more weapons for transport on an all-terrain vehicle without damaging the weapons or creating unwanted noise from jostling. In addition, embodiments of the present invention provide a gun carrier that can be mounted to an all-terrain vehicle without impeding on the space provided for passengers. The gun carrier also provides easy access to one or more guns therein, which can be easily retrieved quickly, quietly, and with minimal movement and noise.

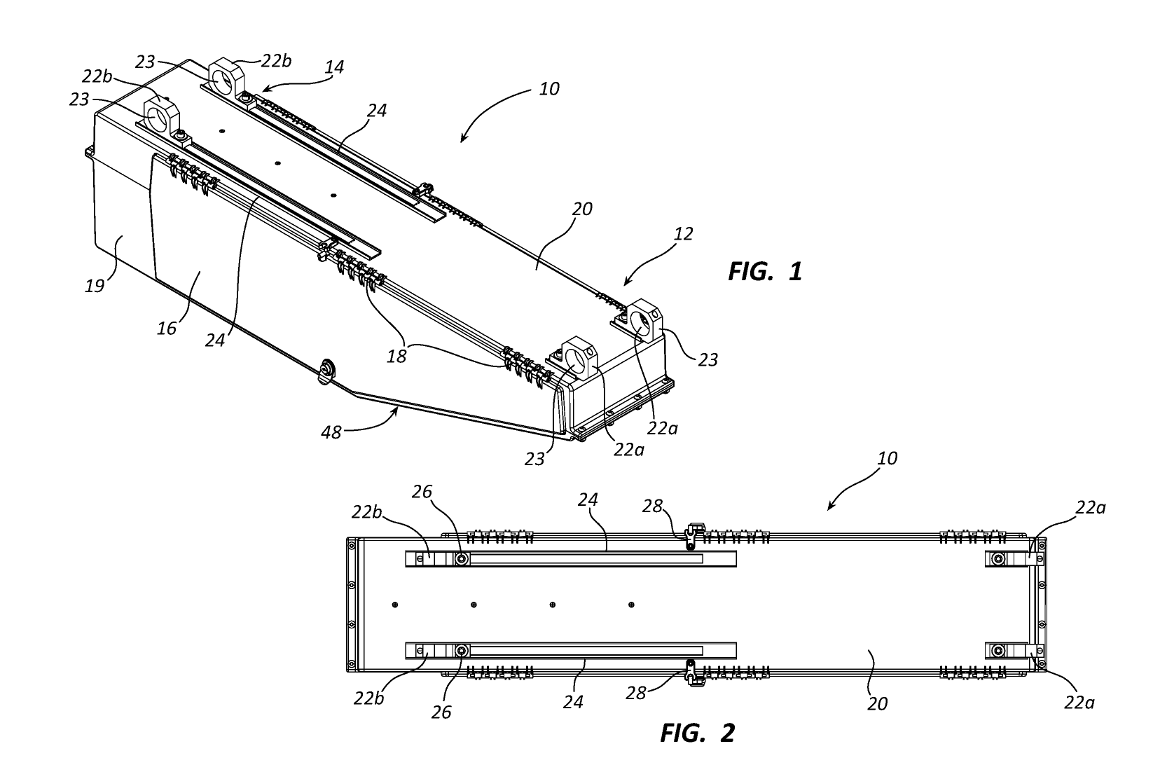

Referring now to the figures, FIG. 1 illustrates a perspective view of a gun carrier 10. The gun carrier 10 includes a body having a head portion 12 and a rear portion 14. A tapered portion 48 slants upward from the rear portion 14 to the head portion 12 so that a side profile of the gun carrier 10 is reduced at the head portion 12 relative to the rear portion 14. In addition, the gun carrier 10 includes a door 16 extending over at least part of the rear portion 14 and part of the head portion 12 on a vertical side surface 19 of the gun carrier 10. The door 16 is configured to open upward via one or more hinges 18 disposed on an upper edge of the gun carrier 10. The gun carrier 10 also includes a door on the opposing side surface, which is not shown in FIG. 1.

The body 13 of the gun carrier 10 also includes a top surface 20 to which a number of fasteners 22a, 22b are secured. In the illustrated embodiment, the fasteners include two front fasteners 22a and two rear fasteners 22b. In at least one embodiment, the front fasteners 22a are secured in place and stationary. The rear fasteners 22b are secured to the top surface 20 of the gun carrier 10 via adjustment slots 24.

In the illustrated embodiment, the fasteners 22a, 22b include rigid clamps having circular through holes 23 for securing around circular bars or frame members of a vehicle. In at least one embodiment, the size of the through holes 23 are adjustable to accommodate a variety of frame member sizes. In at least one embodiment, the shape of the through holes 23 are variable so as to be compatible with frame members of various cross-sectional shapes. Additionally, or alternatively, in at least one embodiment, the fasteners 22a, 22b include one or more other securement mechanisms, such as, but not limited to, straps, latches, buckles, ropes, belts, or the like.

FIG. 2 illustrates the top surface 20 of the gun carrier illustrated in FIG. 1. In at least one embodiment, the rear fasteners 22b are slidably engaged with each slot 24 so as to be adjustable in position along the length of the respective slot 24. Each rear fastener 22b engages the slot 24 via a set screw 26 or other clamping means. In the illustrated embodiment, the set screws 26 can be loosened so that the rear fasteners 22b can slide along the length of the slots 24. Once the correct position of the rear fasteners 22b is achieved, the set screws 26 or other clamping means can be tightened to fix the rear fasteners 22b in position.

In at least one embodiment, the fasteners are sized to fit standard frame members of all-terrain vehicles, such as roll bars, posts, or other frame members. In at least one embodiment, the fasteners 22a, 22b include variable or adjustable sizes to accommodate various sizes and diameters of vehicle frame members.

The rear fasteners 22b are adjustable, as described above, so that the gun carrier 10 can be fitted to frame members of a variety of all-terrain vehicles having frame members of different spacing and size.

In the illustrated embodiment, the rear fasteners 22b are adjustable in position relative to the top surface 20 and the front fasteners 22a are not. In this way, the gun carrier 10 can be adjusted to secure to the roof of an all-terrain vehicle without impinging on the head-space of passengers. For example, the rear fasteners 22b can be adjusted to be forwardly positioned as close to the front fasteners 22a as possible along the slots 24. In such a configuration, if the rear fasteners 22b are secured to a rear-most frame member of the roof of an all-terrain vehicle, the gun carrier 10 will protrude backwards, away from the heads of the passengers.

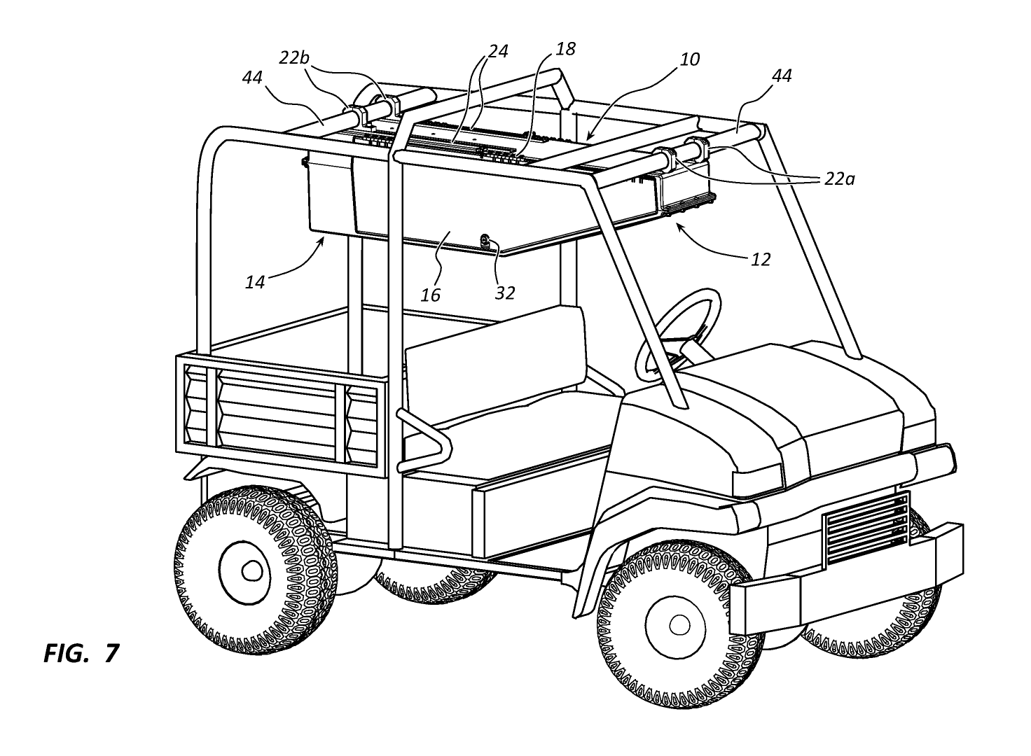

In addition, the slots 24 provide adjustment means for the rear fasteners 22b to accommodate a variety of frame members of all-terrain vehicles that may be spaced differently from one vehicle to the other. Accordingly, the adjustable rear fasteners 22b and slots 24 provide flexibility to attach the gun carrier 10 to a wide variety of vehicles. More details regarding the securement of the gun carrier to an all-terrain vehicle will be given below with reference to FIGS. 7-9.

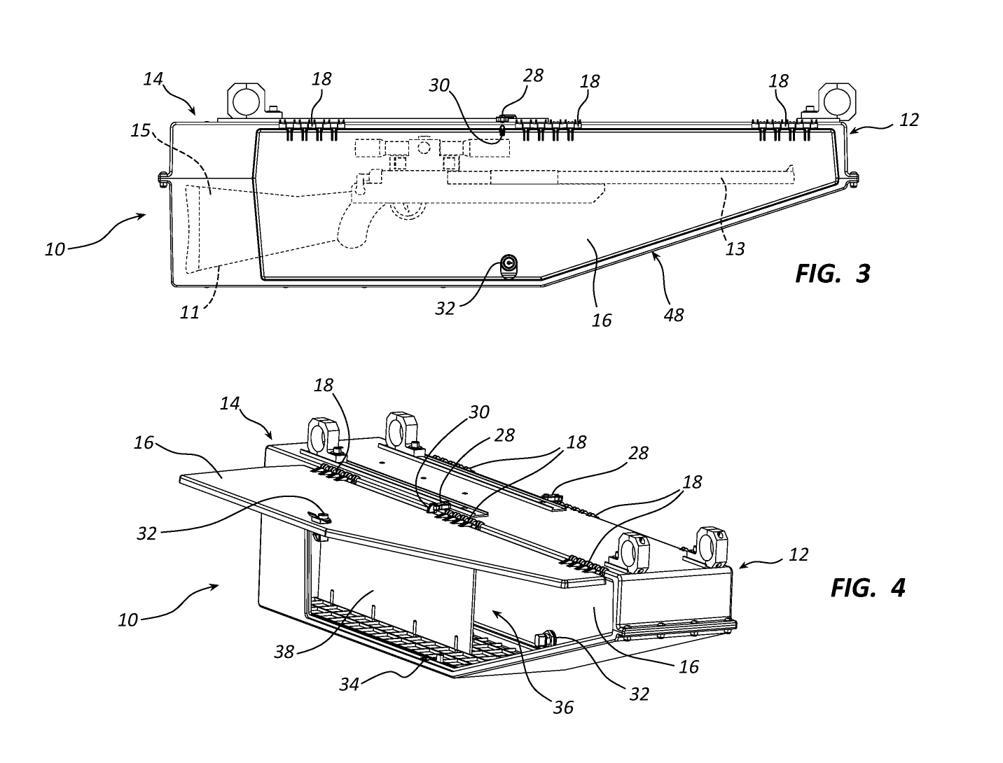

Referring back to FIG. 2, the gun carrier 10 also includes one or more door clips 28 extending near the edges of the top surface 20. As illustrated in the side view of the gun carrier 10 shown in FIG. 3, the door 16 includes a corresponding clip protrusion 30. When the door 16 is opened, as shown in FIG. 4, the clip protrusion 30 snaps into the door clip 28 via a friction fit to maintain the door 16 in an open configuration.

In at least one embodiment, the gun carrier 10 includes more than one door clip 28 and corresponding clip protrusion 30 along each top edge of the door 16 and gun carrier 10. The position and shape of the door clips 28 and clip protrusions 30 may vary in other embodiments. In any case, the door clip 28 and clip protrusion 30 engage one another to maintain the door 16 in an open configuration when opened. The friction fit between the door clip 28 and clip protrusion 30 is overcome upon a force causing the door 16 to close.

In at least one embodiment, the door 16 also includes a locking mechanism 32 that extends through a lower portion of the door 16. When closed, the locking mechanism 32 engages a lower edge 34 of the gun carrier 10 to maintain the door in a closed configuration. The locking mechanism 32 ensures that the door 16 remains closed during operation of the all-terrain vehicle to which the gun carrier 10 is secured.

Additionally, or alternatively, in at least one embodiment, the locking mechanism 32 may be placed elsewhere along any edge of the door 16 to engage the side surface 19 of the gun carrier 10 anywhere around the edge of the opening to the internal compartment 36. In at least one embodiment, a seal is disposed around an outer perimeter edge of the door 16 to seal the door 16 against the gun carrier 10 when closed.

In at least one embodiment of the gun carrier 10, the door 16 is biased open so that the door 16 is only closed when the locking mechanism 32 engages the lower edge 34 of the gun carrier 10. When the locking mechanism 32 is manipulated to open the door 16, the door 16 is biased to open without being lifted. That is, once the locking mechanism 32 is manipulated to disengage from the lower edge 34, the user does not need to physically lift the door 16 into an open configuration. Rather, one or more biasing members attached to the door move the door 16 to an open position for access to the internal compartment.

In at least one embodiment, the hinges 18 of the door 16 are spring-loaded to act as the biasing member(s). Alternatively, in at least one embodiment, the biasing member(s) are separate from the hinges 18. Embodiments of the gun carrier 10 having one or more doors 16 that are biased in an open configuration may not include the door clip 28 and clip protrusion 30 described above.

FIG. 3 also illustrates an exemplary gun 11, shown in dotted lines, for which the gun carrier 10 is configured to carry. The illustrated gun 11 is an example of one type of gun that fits into the gun carrier, but other guns may also be carried. In general, the gun 11 sits within the gun carrier lengthwise along the inside of the gun carrier 10 so that the barrel or front end 13 of the gun 11 is oriented toward the head portion 12 of the gun carrier 10. The stock or rear end 15 of the gun 11 is thus oriented towards the rear portion 14 or rear end of the gun carrier 10.

Also, as seen in FIG. 3, the gun carrier 10 includes a tapered portion 48 extending upward from the bottom of the rear portion 14 to the head portion 12. The tapered portion 48 reduces the total volume of the gun carrier 10 and generally conforms the shape of the gun carrier 10 to the gun 11 disposed therein.

As seen in FIG. 4, the gun carrier 10 is shaped to form an internal compartment 36 configured to house two guns side-by-side. In at least one embodiment, the internal compartment 36 is configured to hold only one gun. In at least one other embodiment, the internal compartment 36 may be configured to house three or more guns. In the illustrated embodiment, the internal compartment is divided by a divider 38 extending at least partially down the longitudinal length of the internal compartment 36. The divider 38 forms a boundary within the internal compartment 36 so that multiple guns residing within the gun carrier 10 do not bump up against one another during transport.

One or more guns can lay side-by-side within the inner compartment 34 of the gun carrier 10 and extend longitudinally along with the length of the gun carrier 10 such that the front of a gun points toward the head portion 12 of the gun carrier 10 and the rear or stock of the gun is oriented toward the rear rear portion 14 of the gun carrier 10.

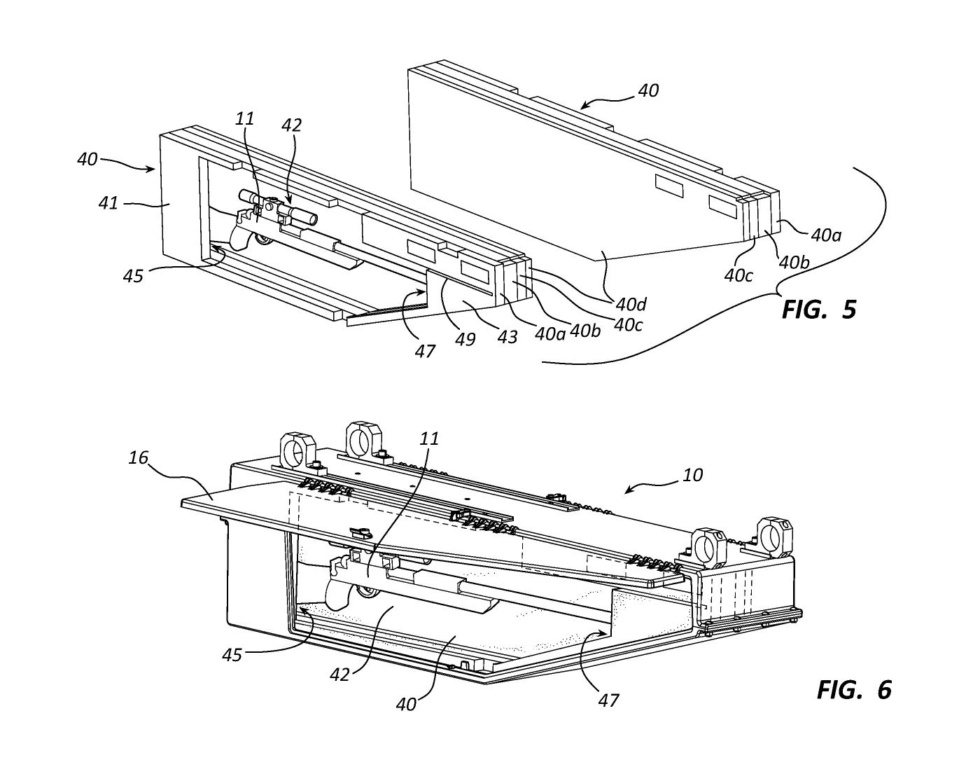

In at least one embodiment, the gun carrier 10 comprises one or more padded inserts 40. FIG. 5 illustrates two padded inserts 40 configured to reside within the internal compartment 36 of the gun carrier 10 illustrated in FIG. 4. In at least one embodiment, two padded inserts 40 are disposed on opposing sides of the divider 38 in the internal compartment 36. Each padded insert 40 comprises a soft material, such as foam or other soft material that cushions the guns residing within the gun carrier 10. Each padded insert 40 includes a recessed portion 42 formed into the thickness of the padded insert 40. The recessed portion 42 forms a cavity into which a gun is inserted.

For example, in at least one embodiment, each padded insert 40 may comprise multiple layers 40a, 40b, 40c, 40d formed together. The profile of each layer 40a, 40b, 40c, 40d may be different so that the recessed portion 42 is formed when the layers 40a, 40b, 40c, 40d are fixed together. For example, in at least one embodiment, a rear layer 40d may be a solid sheet of material and two intermediate layers 40b, 40c may only include outer boundaries of the recessed portion 42. In addition, a front layer 40a having a rear portion 41 and a front portion 43 extending at least partially thereacross may be fixed to the intermediate layers 40b, 40c. In such an embodiment, as illustrated in FIG. 5, the recessed portion 42 includes a rear cavity 45 at least partially defined by the rear portion 41 and a front cavity 47 at least partially defined by the front portion 43.

In addition, the front portion 43 of the front layer 40a includes a slit 49 that allows the front portion 43 to bend downward and away from the recessed portion 42 or otherwise flex to expose and provide access to the front cavity 47 as the barrel of the gun 11 is inserted into the front cavity 47. In at least one embodiment, the slit 49 is positioned on the bottom of the front portion 43 so that the front portion bends upward. The rear or stock of the gun 11 is also inserted into the rear cavity 45. In this way, the padded insert 40 is configured to secure the gun 11 in position within the recessed portion 42. Advantageously, as will be described in further detail below, the padded insert 40 provides padded support for carrying the gun 11 in the gun carrier 10 while traveling on bumpy roads and also provides quick retrieval of the gun 11 from the gun carrier 10.

In at least one embodiment, each padded insert 40 may comprise more or less layers 40a, 40b, 40c, 40d than those shown in FIG. 3. For example, in at least one embodiment, the padded insert 40 is formed as a single piece. In such an embodiment, a foam or other padded material may be formed to include the recessed portion 42, front portion 43 having a slit 49, and rear portion 41 forming the front and rear cavities 47, 45, respectively.

Also, for example, at least one embodiment of the padded insert 40 may include more two layers, three layers, five layers, or more than five layers secured together to form the recessed portion 42, front portion 43 having a slit 49, and rear portion 41 forming the front and rear cavities 47, 45, respectively.

Along these lines, FIG. 6 illustrates an embodiment of a gun carrier 10 with the padded inserts 40 disposed therein. The door 16 is open and the recessed portion 42 of the padded insert 40 faces outward to receive a gun. The front cavity 47 and rear cavity 45 noted above prevent the gun (not shown in FIG. 6) from falling out of the gun carrier 10 when the door 16 is opened. In at least one embodiment, the door 16 does not include any padding on an inner surface thereof to help hold the gun 11 in the gun carrier 10. Rather, in the illustrated embodiment of the padded inserts 40 shown in FIGS. 5 and 6, the padded liner 40 advantageously secures the gun 11 within the internal compartment 36 of the gun carrier 10 independently of the door 16 and regardless of whether the door 16 is in an open configuration or closed configuration.

The padded inserts 40 also reduce jostling of the gun that occurs during transport. If jostling does occur, the padded inserts 40 of the internal compartment 36 reduce damage to the gun from contact with any internal surfaces of the internal compartment 36 of the gun carrier 10. Also, the padded inserts 40 reduces noise associated with jostling of the guns in the internal compartment 36 during transport.

In at least one embodiment, the padded insert 40 secures the gun 11 within the inner compartment 36 of the gun carrier 10 without additional straps or other securement methods inside the inner compartment 36. Thus, advantageously, the padded liners 40 described herein secure and protect one or more guns 11 within the inner compartment 36 of the gun carrier 10 without the hassle and complexity of extra straps or another securement means. The padded liners 40 described herein also provide quick retrieval to pull the gun 11 out of the inner compartment 36 of the gun carrier 10 without needing to undo or release any other straps or securement mechanisms.

Additionally, or alternatively, at least one embodiment of the gun carrier 10 includes straps, clips, belts, or other securement mechanisms inside the inner compartment 36 to secure one or more guns 11 therein. These securement methods may be employed in addition to the padded liners 40 described herein or they may be included in place of the padded liners 40 described herein.

FIG. 7 illustrates a perspective view of the gun carrier 10 secured to the upper portions or frame members 44 of an all-terrain vehicle 46. It is noted that the gun carrier 10 is not limited to being secured to the type of all-terrain vehicle 46 illustrated in FIG. 7. All-terrain vehicles vary widely between manufacturers and types of vehicles. As noted above, the gun carrier 10 of the present disclosure can be secured to a wide range of vehicles due to the adjustability of two or more of the fasteners 22a, 22b on the top surface 20 of the gun carrier 10.

For example, in the illustrated embodiment of FIG. 7, the front fasteners 22a are secured to the front-most frame member 44 of the roof of the vehicle 46 and the rear fasteners 22b are secured to the rear-most frame member 44 of roof of the vehicle 46. However, in at least one embodiment, the rear fasteners 22b are repositioned closer to the front fasteners 22a along the slots 24. In such a configuration, the rear fasteners 22b may still be secured to the rear-most frame member 44 of the vehicle 46 and the front fasteners 22a may be secured to the next rear-most frame member 44 of the vehicle 46. In such a configuration, the gun carrier 10 is positioned further back relative to the vehicle 46. In such a configuration, the gun carrier 10 may even extend behind the vehicle 46 to some degree.

Accordingly, the rear fasteners 22b can be adjusted to vary the position of the gun carrier 10 relative to the vehicle 46. This may be advantageous to provide extra head space to passengers sitting in the vehicle 46. For example, the heads of passengers sitting in the vehicle 46 are positioned toward the head portion 12 of the gun carrier 10 as it is installed in FIG. 7. However, to provide added head space, the gun carrier 10 can be shifted backward to make more room for the heads of passengers in the front of the vehicle 46.

The fasteners 22a, 22b are rigidly attached to the gun carrier 10 and secured over the frame members 44 of the vehicle 46. The fasteners 22a, 22b can take many forms, such as other fasteners known in the art. The fasteners 22a, 22b can be shaped and bent to accommodate various frame elements of different vehicles 46 such that the fasteners 22a, 22b rigidly attach the gun carrier 10 to the vehicle 46. That it, the fasteners 22a, 22b prevent the gun carrier 10 from sliding, shifting, or otherwise changing position relative to the vehicle 46 during transport.

The gun carrier 10 is secured to the vehicle 46 so that the head portion 12 of the gun carrier 10 is oriented toward the front end of the vehicle 46 and the rear portion 14 of the gun carrier 10 is oriented towards the rear end of the vehicle 46. Also, the door 16 is accessible from outside the vehicle 46 when the gun carrier 10 is secured thereon.

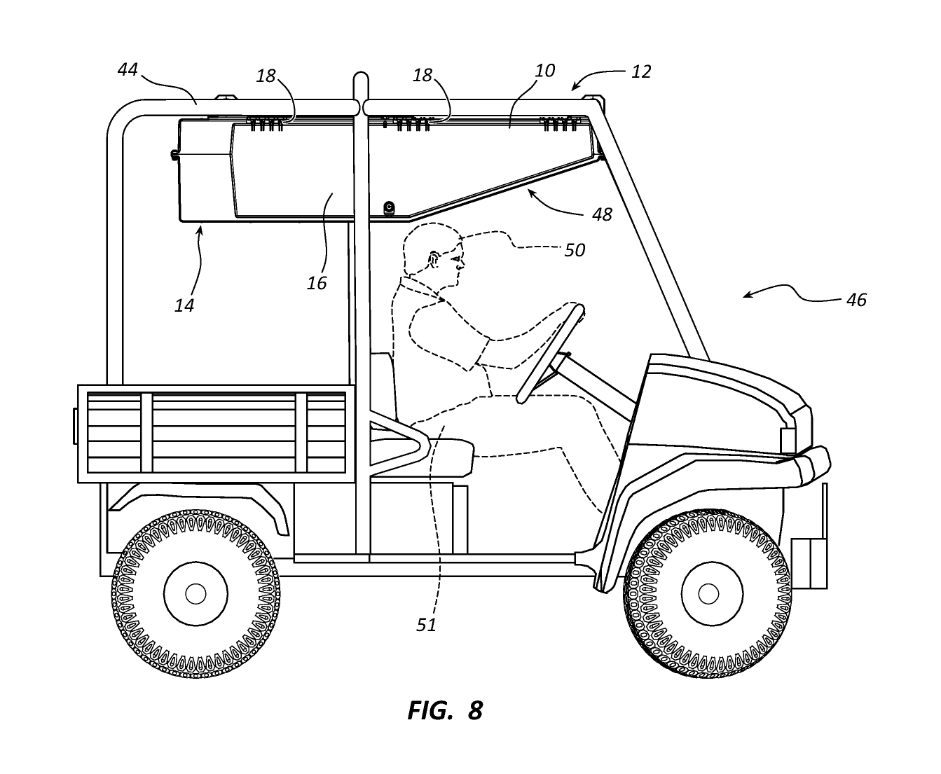

FIG. 8 is a side view of the gun carrier 10 secured to upper frame members, or roof 44, of the vehicle 46 shown in FIG. 7. The gun carrier 10 thus hangs down into the passenger space of the vehicle 46. As seen, the head portion 12 of the gun carrier 10 tapers upward from the rear portion 14 toward the front of the gun carrier 10. This forms a tapered portion 48 that extends above the headspace 50 of one or more passengers 51 sitting in the vehicle 46. Advantageously, the tapered portion 48 prevents the gun carrier 10 from impinging on the headspace 50. Thus, the general shape of the gun carrier, as described herein, allows the passengers to sit comfortably within the vehicle 46 with the gun carrier 10 secured to the vehicle 46 during transport.

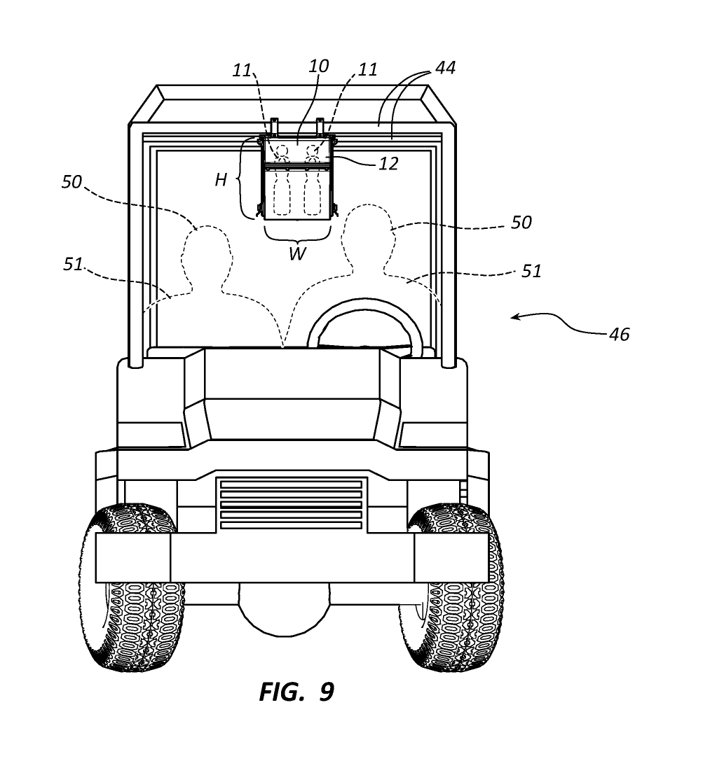

FIG. 9 illustrates a front view of the gun carrier 10 secured to the all-terrain vehicle 46. As seen from the front view, the height H of the gun carrier 10 is greater than the width W of the gun carrier 10. As such, the gun carrier 10 does not impinge on headspace 50 width-wise within the vehicle 46. Accordingly, passengers 51 can sit within the vehicle 46 without the gun carrier 10 impinging upon their space as they sit. The width W of the gun carrier 10 may be even less than the height H in embodiments configured to only carry a single gun, as described above.

For example, the illustrated embodiment of the gun carrier 10 in FIG. 9 is configured to carry two guns side-by-side along the width W thereof. However, an embodiment of a gun carrier 10 configured to carry a single gun may be even narrower, thus impinging less on the headspace 50 of passengers 51.

Referring to both FIGS. 8 and 9, in at least one embodiment, the gun carrier 10 is configured to secure to the upper frame members 44 of an all-terrain vehicle 46 so that the gun carrier 10 hangs down from the upper frame members 44. The specific configuration and shape of the gun carrier 10, as well as the placement of the door 16 and hinges 18 described herein, provide a number of advantages to passengers sitting in the vehicle 46.

For example, the gun carrier 10 can be disposed mainly within an interior space of the vehicle 46 for protection and convenience while still being easily and quickly accessible from outside the vehicle 46. For example, as shown in FIG. 8, the door 16 of the gun carrier 10 is exposed and accessible from the side of the vehicle 46. In this way, as discussed above, when the passengers 51 spot a target and want to quickly access their guns, they can do so quietly with minimal movement.

To do so, the passenger 51 first stops the vehicle 46. The passenger then exits the vehicle 46 and faces the gun carrier 10 from the side thereof. The gun carrier 10 is secured to the upper frame members 44 of the vehicle 46 so that it is level with an upper portion of the passenger 51 when the passenger stands next to the vehicle 46. Thus, no bending or crouching is necessary to access a gun through the door 16 of the gun carrier 10. Advantageously, the gun carrier 10 can be secured in the vehicle 46 as shown so that standing next to the vehicle 46 after exiting puts the passenger 51 in the ideal position to retrieve the gun from the gun carrier 10.

In addition, the passenger does not need to duck or otherwise avoid the gun carrier 10 when exiting the vehicle 46. This is due to the fact that, in at least one embodiment, the gun carrier 10 is positioned between the headspace 50 of the passengers 51 in the middle of the vehicle 46. Thus, stepping out to the side of the vehicle 46 requires no unnatural ducking or other circumventive movements.

Next, the passenger 51 manipulates the locking mechanism 32 so that the door 16 opens upward about the hinges 18. In at least one embodiment, the passenger 51 lifts the door 16 and temporarily secures the door 16 in an open configuration by engaging the door clip 28 and clip protrusion 30 together. Alternatively, in at least one embodiment described herein, the door opens and remains open upon manipulation of the locking mechanism 32 due to the biasing members described herein.

In any case, the door advantageously remains open during retrieval of the gun within the inner compartment 36 so that the passenger 51 can use both hands to retrieve the gun. The passenger 51 does not need to hold the door 16 open while trying to retrieve the gun with only one hand. Having both hands available for gun retrieval reduces awkward movements and retrieval time.

Once the door is open, the passenger retrieves a gun from the internal compartment of the gun carrier 10. As noted above, the padded inserts 40 are configured to maintain the gun in position within the inner compartment 36 of the gun carrier 10. The padded inserts 40 are flexible so that pulling on the gun urges it out from the recessed portion 42 of the insert 40, as described herein.

As noted above, at least one embodiment of the gun carrier 10 includes no other straps or securement mechanisms to secure the gun within the inner compartment 36 of the gun carrier 10. Thus, due to the flexibility of the material of the padded liners 40 described herein, as well as the slit 49 that allows the front portion 43 of the padded liner 40 to bend out and away from the recessed portion 42, the passenger can quietly pull the gun out of the recessed portion 42 of the inner liner 40 with minimal effort. For example, in at least one embodiment, the passenger does not need to undo any straps, noisy Velcro mechanisms, or buttons to retrieve the gun. Rather, the passenger can pull the gun out in one fluid motion.

Also, advantageously, as seen in FIGS. 8 and 9, the gun carrier 10 is positioned so that the barrel of the gun points toward the front of the vehicle 46. Thus, when the passenger 51 retrieves the gun from the inner compartment 36, the gun is already pointed forward.

In many cases, when the passengers 51 spot game or other targets while driving the vehicle 46, they are likely positioned ahead of the vehicle 46 and generally in the direction in which the vehicle 46 is pointed. This is due to the fact that the passengers are generally positioned forward-facing in the vehicle 46 during travel. Thus, when the gun is retrieved from the gun carrier 10, the gun is already pointed in the general direction of the spotted target. Accordingly, the passenger 51 does not need to turn around or drastically reposition his/her body to aim the gun at the target. Accordingly, the configuration, shape, and orientation of the gun carrier 10 secured to upper frame members 44 of the vehicle 46, as shown in FIGS. 8 and 9, reduce the amount of movement and repositioning necessary to retrieve the gun and aim at a target.

The padded inserts 40 of the inner compartment 36 also reduce noise from the gun rubbing or bumping against internal surfaces of the inner chamber as the passenger 51 retrieves the gun through the open door 16. Accordingly, the gun carrier 10 provides easy access to a gun therein, which can be retrieved quickly, quietly, and with minimal movement and noise from the passenger 51.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A gun carrier for securely transporting one or more guns on an all-terrain vehicle, the gun carrier comprising:
a body having a head portion and a rear portion, the body forming an inner compartment configured to house one or more guns therein;
a tapered portion extending upward from a bottom of the rear portion to the head portion;
a door disposed on a vertical side surface of the body, the door providing access to the inner compartment; and
one or more fasteners secured to a top surface of the body, the fasteners being configured to secure the gun carrier to one or more upper frame members of an all-terrain vehicle during use.

2. The gun carrier of claim 1, the one or more fasteners comprising four fasteners.

3. The gun carrier of claim 2, the four fasteners comprising:
two stationary front fasteners secured near the front portion of the body; and
two rear fasteners secured near the rear portion of the body, the rear fasteners being adjustable in position along a length of the top surface of the body.

4. The gun carrier of claim 3, further comprising at least two slots, wherein each rear fastener is slidably engaged with one of the slots so that each of the rear fasteners is adjustable in position along a length of the slot with which the rear fastener is slidably engaged.

5. The gun carrier of claim 1, further comprising a padded insert disposed inside the inner compartment.

6. The gun carrier of claim 5, wherein the padded insert comprises:
a recessed portion configured to secure a gun within the internal compartment during use, the recessed portion comprising:
a rear cavity configured to receive a stock of a gun during use; and
front cavity configured to receive a barrel of a gun during use.

7. The gun carrier of claim 6, wherein the padded insert comprises:
a front portion at least partially defining the front cavity; and
a slit configured to allow the front portion to bend and provide access to the front cavity.

8. The gun carrier of claim 1, further comprising:
a clip extending from a top edge of a top surface of the body; and
a clip protrusion extending from a top edge of the door,
wherein a position of the clip corresponds to a position of the clip protrusion so that when the door is open during use, the clip and clip protrusion engage one another to maintain the door in an open configuration.

9. The gun carrier of claim 1, further comprising:
a locking mechanism configured to keep the door in a closed configuration during use;
a biasing member that opens the door and maintains the door in an open configuration when the locking mechanism is manipulated to release the door from the closed configuration during use.

10. The gun carrier of claim 9, wherein the biasing member comprises a spring-loaded hinge connecting the door to the body.

11. The gun carrier of claim 1, further comprising a divider extending at least partially down a longitudinal length of the inner compartment, the divider configured to form a boundary within the internal compartment so that multiple guns may reside within the gun carrier without bumping against each other during use.

12. A gun carrier that can be mounted to an all-terrain vehicle, the gun carrier comprising:
a body forming an inner compartment;
a tapered portion extending upward from a rear portion of the body to a head portion of the body;
one or more fasteners secured to a top surface of the body, the one or more fasteners configured to secure the body to upper frame members of an all-terrain vehicle such that:
the body extends vertically downward from the upper frame members;
the body is disposed between headspaces of passengers positioned in the all-terrain vehicle during use; and
the tapered portion extends upward so that the head portion resides above headspaces of passengers positioned in the all-terrain vehicle during use.

13. The gun carrier of claim 12, wherein:
the gun carrier further comprises a door disposed on a side surface of the body, the door providing access to an inner compartment within the gun carrier; and
the door is accessible from outside the all-terrain vehicle when the gun carrier is secured to the upper frame members.

14. The gun carrier of claim 12, wherein:
a height of the gun carrier is greater than a width of the gun carrier; and
the gun carrier is configured to hold two or more guns side by side width-wise within the internal compartment.

15. The gun carrier of claim 12, the one or more fasteners comprising:
one or more rear fasteners positioned towards the rear portion of the body, the one or more rear fasteners being adjustable along a length of the body; and
one or more front fasteners positioned toward the head portion, the one or more front fasteners being stationary relative to the body.

16. The gun carrier of claim 12, the door comprising a locking mechanism, wherein when the locking mechanism is manipulated to open the door, the door maintains an open configuration.

17. A method of carrying a gun on an all-terrain vehicle, comprising:
providing a gun carrier, comprising:
a body having a rear portion and a head portion;
a tapered portion extending upward and forward from a bottom of the rear portion to the head portion;
two or more fasteners secured to a top surface of the body, the two or more fasteners comprising:
a front stationary fastener positioned toward the head portion; and
a rear adjustable fastener positioned toward the rear portion;
adjusting a position of the rear adjustable fastener to be spaced apart from the front stationary fastener to match a spacing between two upper frame members of the all-terrain vehicle;
securing the two or more fasteners to the upper frame members so that:
the tapered portion extends above headspaces of the all-terrain vehicle; and
the body extends vertically downward from the upper frame members between headspaces of the all-terrain vehicle.

18. The method of claim 17, the gun carrier further comprising a door extending along a side surface of the body, the door providing access to an internal compartment of the body.

19. The method of claim 18, wherein:
the door is configured to open upward about one or more hinges connecting an upper edge of the door to the body of the gun carrier; and
the door is configured to maintain an open configuration when opened.

20. The method of claim 19, further comprising:
opening the door;
inserting a gun into a recessed portion of a padded liner disposed inside an inner compartment of the body by:
inserting the stock of the gun into a rear cavity of the recessed portion;
inserting the barrel of the gun into a front cavity of the recessed portion; and
closing the door.
